(19) United States
(12) Patent Application Publication
(10) Pub. No.: US 2014/0074614 A1
(43) Pub. Date: Mar. 13, 2014

(54) TIME SERIES-BASED ENTITY BEHAVIOR CLASSIFICATION

(71) Applicant: GLOBYS, INC., Seattle, WA (US)

(72) Inventors: Courosh Mehanian, Redmond, WA (US); Luca Cazzanti, Seattle, WA (US); Julie Penzotti, Seattle, WA (US); Jackson Feng, Snoqualmie, WA (US); Oliver Downs, Redmond, WA (US)

(73) Assignee: GLOBYS, INC., Seattle, WA (US)

(21) Appl. No.: 13/830,957

(22) Filed: Mar. 14, 2013

Related U.S. Application Data
(60) Provisional application No. 61/700,195, filed on Sep. 12, 2012.

(51) Int. Cl. G06Q 30/02

(52) U.S. Cl. CPC G06Q 30/0267
USPC 705/14.64

(57) ABSTRACT

Techniques are disclosed that leverage time series techniques to express entity-activity data in a longitudinal temporal form, which may then be employed to dynamically classify the entity's behavior. In some embodiments, groupings or segmentations of different entities that exhibit similar profiles of longitudinal temporal form are identified using various techniques, including frequency-domain analysis, and/or unsupervised model-based clustering. The clustering of entities enables directing of offerings to, for example, a telecommunication's customer based on characteristics of the cluster.

### CROSS-REFERENCE TO RELATED APPLICATIONS

This non-provisional patent application claims the benefit at least under 35 U.S.C. §119(e) of U.S. Provisional Patent Application Ser. No. 61/700,195, filed on Sep. 12, 2012, entitled “Time Series-Based Entity Behavior Classification,” which is incorporated herein by reference.

### TECHNICAL FIELD

The present invention relates generally to providing targeted offerings to at least a telecommunications customer and, more particularly, but not exclusively to leveraging time series techniques that express entity-activity data in a longitudinal temporal form to dynamically classify the entity's behavior.

### BACKGROUND

The dynamics in today's telecommunications market are placing more pressure than ever on networked services providers to find new ways to compete. With high penetration rates and many services nearing commoditization, many companies have recognized that it is more important than ever to find new ways to bring the full and unique value of the network to their customers. In particular, these companies are seeking new solutions to help them more effectively up-sell and/or cross-sell their products, services, content, and applications, successfully launch new products, and create long-term value in new business models.

One traditional approach for marketing a particular product or service to telecommunications customers includes broadcasting a variety of generic offerings to customers to see which ones are popular. However, providing these mass marketing product offerings to a customer may significantly reduce the likelihood that the product will be purchased. It may also result in marketing overload for a customer. Therefore many vendors seek better approaches to marketing their products to their customers. Some approaches include performing various types of analysis on their customer data to try to better understand a customer's needs. However, much of the data from a telecommunications' provider may be incomplete or inconsistently collected. In many instances, the data might be collected for various customers over non-uniform times of day. Often the data may be collected, for example, at different times of a day for different customers, or even for the same customer. Conducting meaningful analysis on inconsistent and apparently randomly collected data is often challenging. Therefore, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 is a system diagram of one embodiment of an environment in which the techniques may be practiced;

FIG. 2 shows one embodiment of a client device that may be included in a system implementing the techniques;

FIG. 3 shows one embodiment of a network device that may be included in a system implementing the techniques;

FIG. 4 shows one embodiment of a contextual marketing architecture using time series-based classifiers;

FIG. 5 shows one embodiment of a flow diagram of a process for performing time-series based customer behavior segmentation usable to provide an offering to the customer;

FIG. 6 shows one embodiment of a flow diagram of a process of performing frontend processing within the process of FIG. 5;

FIG. 7 illustrates a non-limiting, non-exhaustive example of the results of performing the frontend processing on simulated data based on actions from the process of FIG. 6;

FIG. 8 shows one embodiment of aggregating coefficients, usable within the process of FIG. 6;

FIG. 9 shows one embodiment of a flow diagram of a process of training the segmentation model within the process of FIG. 5;

FIG. 10 disclose one embodiment of choosing the number of training samples, usable in the process of FIG. 9;

FIG. 11 discloses one embodiment of choosing the number of clusters, usable in the process of FIG. 9;

FIG. 12 shows one embodiment of a flow diagram of a process of performing data scoring within the process of FIG. 5;

FIG. 13 illustrates a non-limiting, non-exhaustive example of the output behavioral segments of the process of FIG. 5; and

FIG. 14 illustrates a non-limiting, non-exhaustive example of employing the time-series-based behavioral segmentation to dynamically determine market offerings to one of the behavioral segments shown in FIG. 13.

### DETAILED DESCRIPTION

The present techniques now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The various occurrences of the phrase “in one embodiment” as used herein do not necessarily refer to the same embodiment, though they may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “customer” and “subscriber” may be used interchangeably to refer to an entity that has or is predicted to in the future make a procurement of a product, service, content, and/or application from another entity. As such, customers include not just an individual but also businesses, organizations, or the like. Further, as used herein, the term “entity” refers to a customer, subscriber, or the like.

As used herein, the terms “networked services provider”, “telecommunications”, “telecom”, “provider”, “carrier”, and “operator” may be used interchangeably to refer to a provider of any network-based telecommunications media, product, service, content, and/or application, whether inclusive of or independent of the physical transport medium that may be employed by the telecommunications media, products, services, content, and/or application. As used herein, references to “products/services,” or the like, are intended to include products, services, content, and/or applications, and is not to be construed as being limited to merely “products and/or services.” Further, such references may also include scripts, or the like.

As used herein, the terms “optimized” and “optimal” refer to a solution that is determined to provide a result that is considered closest to a defined criteria or boundary given one or more constraints to the solution. Thus, a solution is considered optimal if it provides the most favorable or desirable result, under some restriction, compared to other determined solutions. An optimal solution therefore, is a solution selected from a set of determined solutions.

As used herein, the terms “offer” and “offering” refer to a networked services provider's product, service, content, and/or application for purchase by a customer. An offer or offering may be presented to the customer using any of a variety of mechanisms. Thus, the offer or offering is independent of the mechanism by which the offer or offering is presented.

The following briefly describes the embodiments in order to provide a basic understanding of some aspects of the techniques. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are disclosed herein that leverage time series techniques to express entity-activity data in a longitudinal temporal form, which may then be employed to dynamically classify the entity's behavior. In some embodiments, groupings or segmentations of different entities that exhibit similar profiles of longitudinal temporal form are identified using various techniques, including frequency-domain analysis, and/or unsupervised model-based clustering. The clustering of entities enables directing of offerings to a telecommunication provider's customers based on characteristics of the cluster.

Data about telecommunication customers, or other entities, are received, where the data may be incomplete or inconsistently recorded. For example, some information about an entity might be recorded at one time for a first day, and no data might be recorded on a second day at the same time of the day. In any event, information obtained from the entities' behavior may be recorded as a time series within a specified time window. The time series may represent the entities' activity and can be uni- or multi-variate. The activity may be characterized using attributes extracted from the time series. Some embodiments disclosed herein include extracting attributes that express a frequency-domain representation of the activity. Other embodiments may represent the activity using various mathematical models of the activity. The models may be deterministic or stochastic. Entities determined to exhibit similar activity patterns are grouped together using any of a variety of clustering techniques. One embodiment employs a k-means clustering technique; however, another embodiment may employ model-based clustering techniques. The clustering may be carried out on a set of entity activity profiles referred to as a training set. The groupings determined through the clustering technique may be recorded and applied to entity activity profiles that are not part of the training set. Clustering of entities enables focused marketing based on similar characteristics of members in the cluster.

It is noted that many of the conventional segmentation mechanisms used previous to the current invention tend to key on static attributes for an entity. Such mechanisms however often provide a limited snapshot on which to base a grouping of entities. Therefore, embodiments described herein are directed towards addressing such deficiencies by including longitudinal data that is intended to capture an entity's actual behavior over time. Thus as disclosed, dynamic classifications of entities are performed making it possible to capture changes in an entity's behavior that static attributes may miss. Further, as described, various embodiments are directed towards permitting discovery of incompatibilities between static attributes and actual behavior. In the context of customer segmentation, this capability can be used to provide recommended selections or offerings to better match a customer's actions.

It is noted that while embodiments here disclose applications to telecommunications customers, where the customers are different from the telecommunications providers, other intermediate entities may also benefit from the subject innovations disclosed herein. For example, banking industries, cable television industries, retailers, wholesalers, or virtually any other industry in which that industry's customers interact with the services and/or products offered by an entity within that industry.

Illustrative Operating Environment

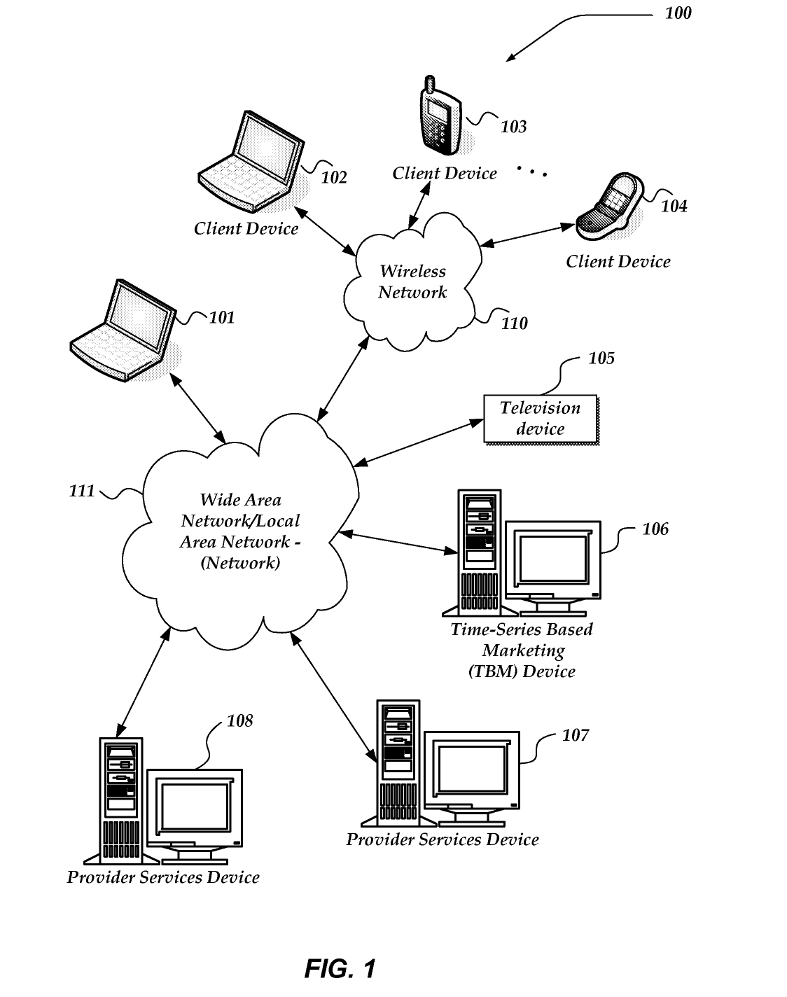

FIG. 1 shows components of one embodiment of an environment in which the invention may be practiced. Not all the components may be required to practice the invention, and variations in the arrangement and type of the components may be made without departing from the spirit or scope of the subject innovations. As shown, system 100 of FIG. 1 includes local area networks (“LANs”)/wide area networks (“WANs”)-(network) 111, wireless network 110, client devices 101-105, Time-Series Based Marketing (TBM) device 106, and provider services 107-108.

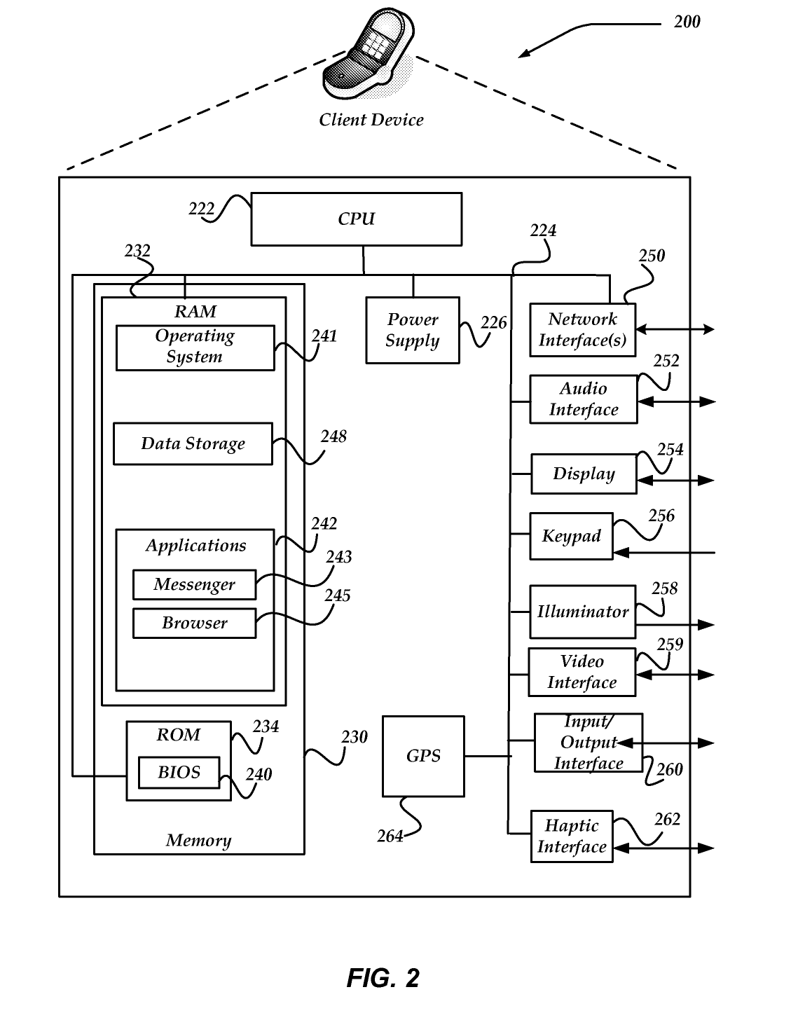

One embodiment of a client device usable as one of client devices 101-105 is described in more detail below in conjunction with FIG. 2. Generally, however, client devices 102-104 may include virtually any computing device capable of receiving and sending a message over a network, such as wireless network 110, wired networks, satellite networks, virtual networks, or the like. Such devices include wireless devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as telephones, televisions, video recorders, cable boxes, gaming consoles, personal computers, multiprocessor systems, microprocessor-based or programmable consumer electronics, network PCs, or the like. Further, as illustrated, client device 105 represents one embodiment of a client device operable as a television device. In one embodiment, one or more of client devices 101-105 may also be configured to operate over a wired and/or a wireless network.

Client devices 101-105 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color display in which both text and graphics may be displayed.

A web-enabled client device may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-105 also may include at least one other client application that is configured to receive information and other data from another computing device. The client application may include a capability to provide and receive textual content, multimedia information, or the like. The client application may further provide information that identifies itself, including a type, capability, name, or the like. In one embodiment, client devices 101-105 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

In one embodiment, client devices 101-105 may further provide information useable to detect a location of the client device. Such information may be provided in a message, or sent as a separate message to another computing device.

Client devices 101-105 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, between another computing device. However, the present invention is not limited to these message protocols, and virtually any other message protocol may be employed.

Client devices 101-105 may further be configured to include a client application that enables the user to log into a user account that may be managed by another computing device. Information provided either as part of a user account generation, a purchase, or other activity may result in providing various customer profile information. Such customer profile information may include, but is not limited to purchase history, current telecommunication plans about a customer, and/or behavioral information about a customer and/or a customer's activities.

Wireless network 110 is configured to couple client devices 102-104 with network 111. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 111 couples TBM device 106, provider service devices 107-108, and client devices 101 and 105 with other computing devices, and allows communications through wireless network 110 to client devices 102-104. Network 111 is enabled to employ any form of computer readable media for communicating information from one electronic device to another. Also, network 111 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 111 includes any communication method by which information may travel between computing devices.

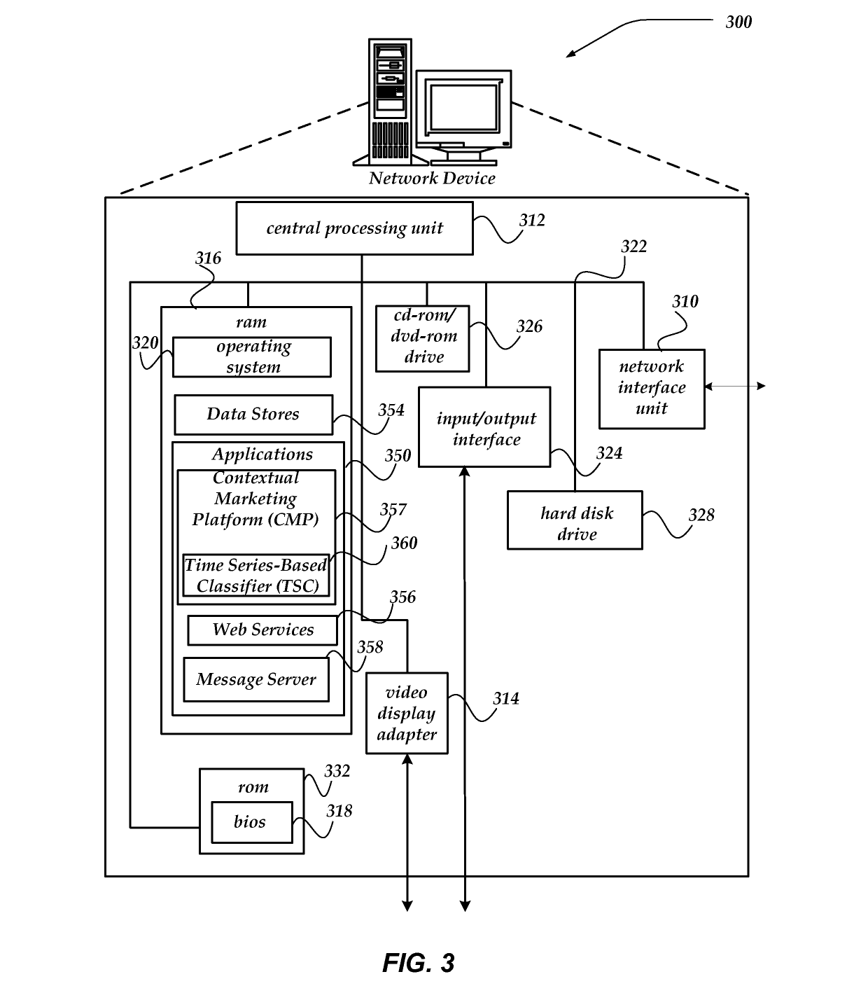

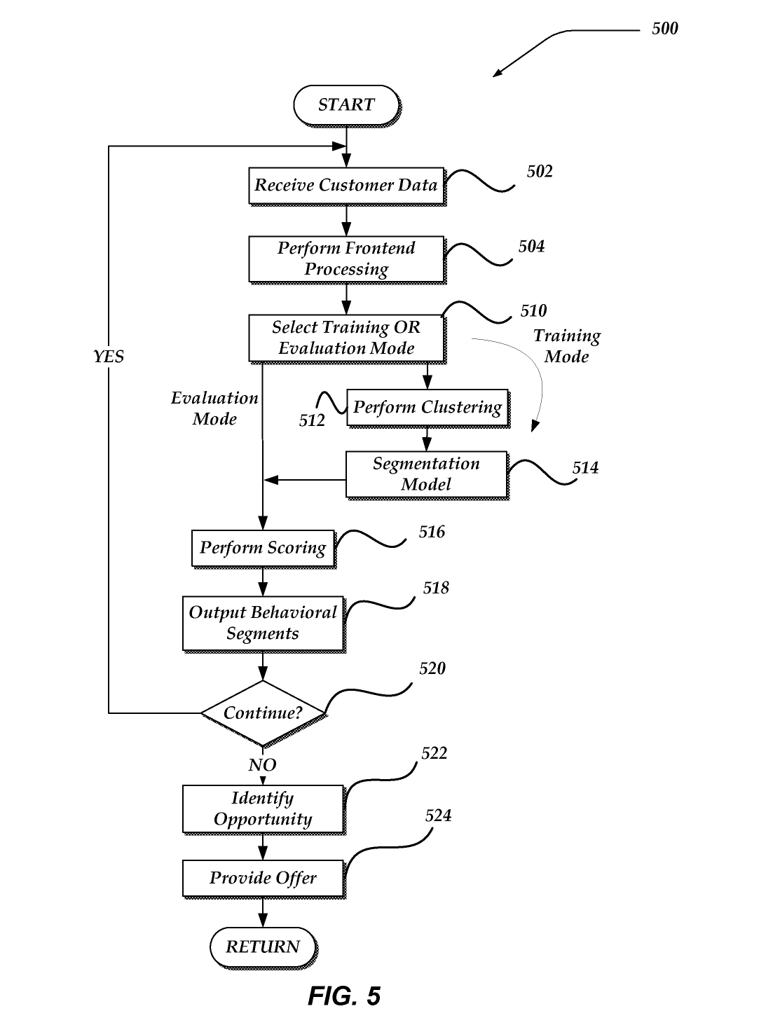

One embodiment of a TBM device 106 is described in more detail below in conjunction with FIG. 3. Briefly, however, TBM device 106 includes virtually any network computing device that is configured to proactively and contextually target offers to customers based on time series-based entity behavior classifications as described in more detail below in conjunction with FIG. 5.

Devices that may operate as TBM device 106 include, but are not limited to personal computers, desktop computers, multiprocessor systems, microprocessor-based or programmable consumer electronics, network PCs, servers, network appliances, and the like.

Although TBM device 106 is illustrated as a distinct network device, the invention is not so limited. For example, a plurality of network devices may be configured to perform the operational aspects of TBM device 106. For example, data collection might be performed by one or more set of network devices, while entity behavior classifications, and/or reporting interfaces, and/or the like, might be provided by one or more other network devices.

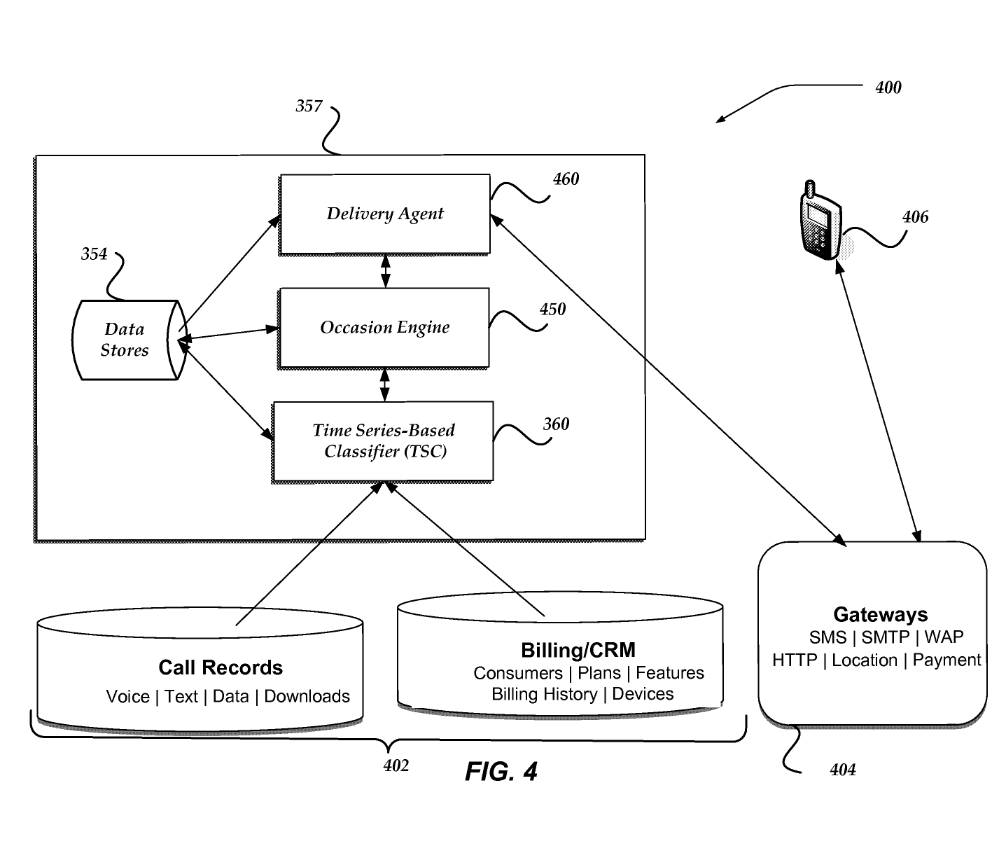

Provider service devices 107-108 include virtually any network computing device that is configured to provide to TBM device 106 information including networked services provider information, customer information, and/or other context information for use in generating and selectively pushing or otherwise presenting a customer with targeted customer offers. In some embodiments, provider service devices 107-108 may provide various interfaces, including, but not limited to those described in more detail below in conjunction with FIG. 4.

### Illustrative Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one of client devices 101-105 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values.

GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer readable storage media for storage of information such as computer readable instructions, data structures, program modules, or other data. Computer readable storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Mass memory 230 stores a basic input/output system (“BIOS”) 240 for controlling low-level operation of client device 200. The mass memory also stores an operating system 241 for controlling the operation of client device 200. It will be appreciated that this component may include a general-purpose operating system such as a version of UNIX, or LINUX™, or a specialized client operating system, for example, such as Windows Mobile™, PlayStation 3 System Software, the Symbian® operating system, or the like. The operating system may include, or interface with a Java virtual machine module that enables control of hardware components and/or operating system operations via Java application programs.

Memory 230 further includes one or more data storage 248, which can be utilized by client device 200 to store, among other things, applications 242 and/or other data. For example, data storage 248 may also be employed to store information that describes various capabilities of client device 200, as well as store an identifier. The information, including the identifier, may then be provided to another device based on any of a variety of events, including being sent as part of a header during a communication, sent upon request, or the like. In one embodiment, the identifier and/or other information about client device 200 might be provided automatically to another networked device, independent of a directed action to do so by a user of client device 200. Thus, in one embodiment, the identifier might be provided over the network transparent to the user.

Moreover, data storage 248 may also be employed to store personal information including but not limited to contact lists, personal preferences, purchase history information, user demographic information, behavioral information, or the like. At least a portion of the information may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VoIP applications, contact managers, task managers, transcoders, database programs, word processing programs, security applications, spreadsheet programs, games, search programs, and so forth. Applications 242 may include, for example, messenger 243, and browser 245.

Browser 245 may include virtually any client application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web-based languages may also be employed.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols. Messenger 243 and/or browser 245 may be employed by a user of client device 200 to receive selectively targeted offers of a product/service based on entity behavior classifications.

### Illustrative Network Device Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, TBM device 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable device, namely computer storage devices. Computer readable storage devices may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory, physical devices which can be used to store the desired information and which can be accessed by a computing device.

The mass memory also stores program code and data. For example, mass memory might include data store 354. Data store 354 may be include virtually any mechanism usable for store and managing data, including but not limited to a file, a folder, a document, or an application, such as a database, spreadsheet, or the like. Data store 354 may manage information that might include, but is not limited to web pages, information about members to a social networking activity, contact lists, identifiers, profile information, tags, labels, or the like, associated with a user, as well as scripts, applications, applets, and the like.

One or more applications 350 may be loaded into mass memory and run on operating system 320. Examples of application programs may include transcoders, schedulers, calendars, database programs, word processing programs, HTTP programs, customizable user interface programs, IPSec applications, encryption programs, security programs, VPN programs, web servers, account management, games, media streaming or multicasting, and so forth. Applications 350 may include web services 356, Message Server (MS) 358, and Contextual Marketing Platform (CMP) 357. As shown, CMP 357 includes Time Series-Based Classifier (TSC) 360.

Web services 356 represent any of a variety of services that are configured to provide content, including messages, over a network to another computing device. Thus, web services 356 include for example, a web server, messaging server, a File Transfer Protocol (FTP) server, a database server, a content server, or the like. Web services 356 may provide the content including messages over the network using any of a variety of formats, including, but not limited to WAP, HDML, WML, SMGL, HTML, XML, cHTML, xHTML, or the like. In one embodiment, web services 356 might interact with CMP 357 to enable a networked services provider to track customer behavior, and/or provide contextual offerings based on a time series-based entity behavior classification.

Message server 358 may include virtually any computing component or components configured and arranged to forward messages from message user agents, and/or other message servers, or to deliver messages to a local message store, such as data store 354, or the like. Thus, message server 358 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, Session Initiation Protocol (SIP), or the like.

However, message server 358 is not constrained to email messages, and other messaging protocols may also be managed by one or more components of message server 358. Thus, message server 358 may also be configured to manage SMS messages, IM, MMS, IRC, mIRC, or any of a variety of other message types. In one embodiment, message server 358 may also be configured to interact with CMP 357 and/or web services 356 to provide various communication and/or other interfaces useable to receive provider, customer, and/or other information useable to determine and/or provide contextual customer offers.

One embodiment of CMP 357 is described further below in conjunction with FIG. 4. However, briefly, CMP 357 is configured to receive various historical data from networked services providers about their customers, including customer profiles, billing records, usage data, purchase data, types of mobile devices, and the like. CMP 357 may then perform analysis including time series-based entity behavior classifications. In one embodiment, CMP 357 employs entity behavior classifications to identify a plurality of occasions (or contexts) when it may be desirable to interact with any particular customer.

CMP 357 monitors ongoing historical and/or real-time data from the networked services provider or external sources to detect or predict within a combination of a plurality of confidence levels, when an occasion is likely to occur for particular customers. Then, based on a detected or predicted occurrence of an occasion for a customer, CMP 357 may select an offer targeted to the customer. The selected offer may then be presented to the customer. However, in one embodiment, CMP 357 might determine that no offer is to be presented to the customer based in part on none of the available offers having a likelihood of being accepted by the customer that exceeds a given threshold. In this manner, the customer is selectively presented with an offer at a time, location, and in an entity behavior classification defined situation when they are predicted to be most emotionally receptive to the offering, while avoiding sending offers that are likely to not be accepted during the given occasion by the customer. In one embodiment, the given threshold is selected for each customer based on the customer's previous purchases for similar products/services, and the like.

### Illustrative Time Series-Based Marketing Architecture

FIG. 4 shows one embodiment of an architecture useable to perform contextual occasion marketing for contextual offers to be delivered to the customer based on detection of an occasion occurrence for the customer. Architecture 400 of FIG. 4 may include many more components than those shown. The components shown, however, are sufficient to disclose an illustrative embodiment for practicing the invention. Architecture 400 may be deployed across components of FIG. 1, including, for example, TBM device 106, client devices 101-105, and/or provider services 107-108.

Architecture 400 is configured to make selection decisions from entity behavior classifications of historical networked services provider's customer usage records, billing data, and the like. Occasions are identified based on the analytics, and monitored to identify and/or predict their occurrence for customers. Offers to the customer during the occurrence of an occasion are optimized according to a customer's interests and preferences as determined by the historical data and the nature of the occasion. Each offer is directed to be optimized to resonate with the customer—highly targeted, relevant, and timely. At the same time, in one embodiment, if for a given customer it is determined that no offer is likely to be accepted by the customer for a given occasion, then no offer is delivered to the customer. In this manner, the customer is not overwhelmed with unnecessary and undesired offerings. Such unnecessary offerings might be perceived by the customer as spam, potentially resulting in decreasing receptivity by the customer to future offers.

In any event, not all the components shown in FIG. 4 may be required to practice the invention and variations in the arrangement and type of the components may be made without departing from the spirit or scope of the subject innovation. As shown, however, architecture 400 includes a CMP 357, networked services provider (NSP) data stores 402, communication channel or communication channels 404, and client device 406.

Client device 406 represents a client device, such as client devices 101-105 described above in conjunction with FIGS. 1-2. NSP data stores 402 may be implemented within one or more services 107-108 of FIG. 1. As shown, NSP data stores 402 may include a Billing/Customer Relationship Management (CRM) data store, and a Network Usage Records data store. However, the subject innovation is not limited to this information, and other types of data from networked services providers may also be used. The Billing/CRM data may be configured to provide such historical data as a customer's profile, including their billing history, customer service plan information, service subscriptions, feature information, content purchases, client device characteristics, and the like. Usage Records may provide various historical data including but not limited to network usage record information including voice, text, internet, download information, media access, and the like. NSP data stores 402 may also provide information about a time when such communications occur, as well as a physical location for which a customer might be connected to during a communication, and information about the entity to which a customer is connecting. Such physical location information may be determined using a variety of mechanisms, including for example, identifying a cellular station that a customer is connected to during the communication. From such connection location information, an approximate geographic or relative location of the customer may be determined.

CMP 357 is streamlined for occasion identification and presentation. Only a small percentage of the massive amount of incoming data might be processed immediately. The remaining records may be processed from a buffer to take advantage of processing power efficiently over a full 24 hours. As the raw data is processed into predictive scores, times, statistics and other supporting data, it may be discarded from the system, in one embodiment, leaving a sustainable data set that scales as a function of consumer base.

Communication channels 404 include one or more components that are configured to enable network devices to deliver and receive interactive communications with a customer. In one embodiment, communication channels 404 may be implemented within one or more of provider services 107-108, and/or client devices 101-105 of FIG. 1, and/or within networks 110 and/or 111 of FIG. 1.

The various components of CMP 357 are described further below. Briefly, however, CMP 357 is configured to receive customer data from NSP data stores 402. CMP 357 may then employ time series-based classifier (TSC) 360 to classify entities. CMP 357 may further use then employ the results of the entity based classifications within occasions engine 450 to determine to whom and when to provide an offering to a customer. The results of occasions engine 450 may be provided to a customer through deliver agent 460.

The following sections provide more detail on various actions performed at least by TSC 450.

### Generalized Operation

The operation of certain additional general aspects of the subject innovation will now be described with respect to FIGS. 5-14. Actions described in these figures are performed by one or more components within TBM 106 of FIG. 1.

FIG. 5 shows one embodiment of a flow diagram of a process for performing time-series based customer behavior segmentation usable to provide an offering to the customer. The process of FIG. 5 may be performed for example by TSC 360 of FIG. 3.

Process 500 of FIG. 5, begins, after a start block, at block 502, where customer data is received. In one embodiment, the customer data is temporal customer data. Briefly, temporal customer data may be used to segment customers in behaviorally similar segments or clusters. Temporal data may include balance, recharge activity, incoming (plus/and/or) outgoing voice activity, incoming (plus/and/or) outgoing SMS activity, data usage, and the like. Further, as discussed above, a small fraction of the total available customer data might be used to train the segmentation model. In one embodiment, the clustering techniques might include an unsupervised clustering algorithm.

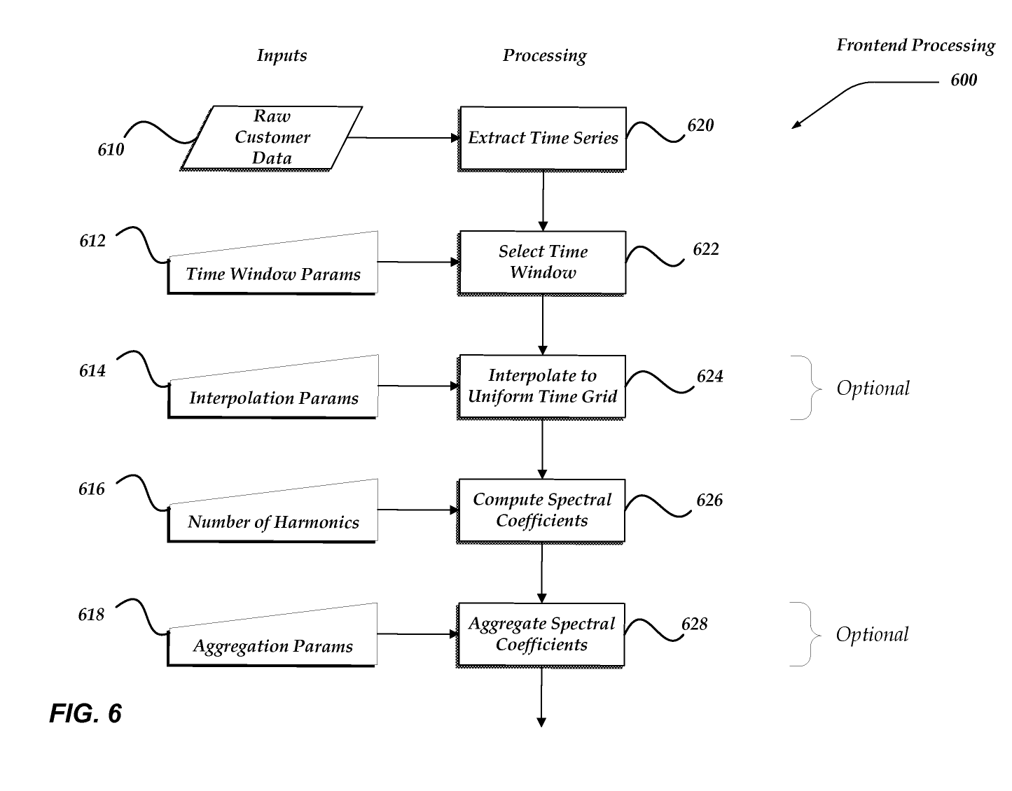

Processing next flows to block 504, where frontend processing is performed. Block 504 is described in more detail below in conjunction with process 600 of FIG. 6. Briefly, however, at block 504, a time series representation of the customer data received at block 502 (sometimes also called raw data) is extracted. A frequency-domain analysis is then performed on the time series data to compute a set of spectral coefficients, or generally, spectral content.

Processing next flows to block 510, where a determination is made whether to select to train the model using the received data, or to perform a classification of the received data using an evaluation mode. The determination may be based on a variety of criteria, including a switch value, a time period since a previous training was performed, or the like. For example, if no training of the model has been performed, then the flow direction of process 500 is to perform the training mode.

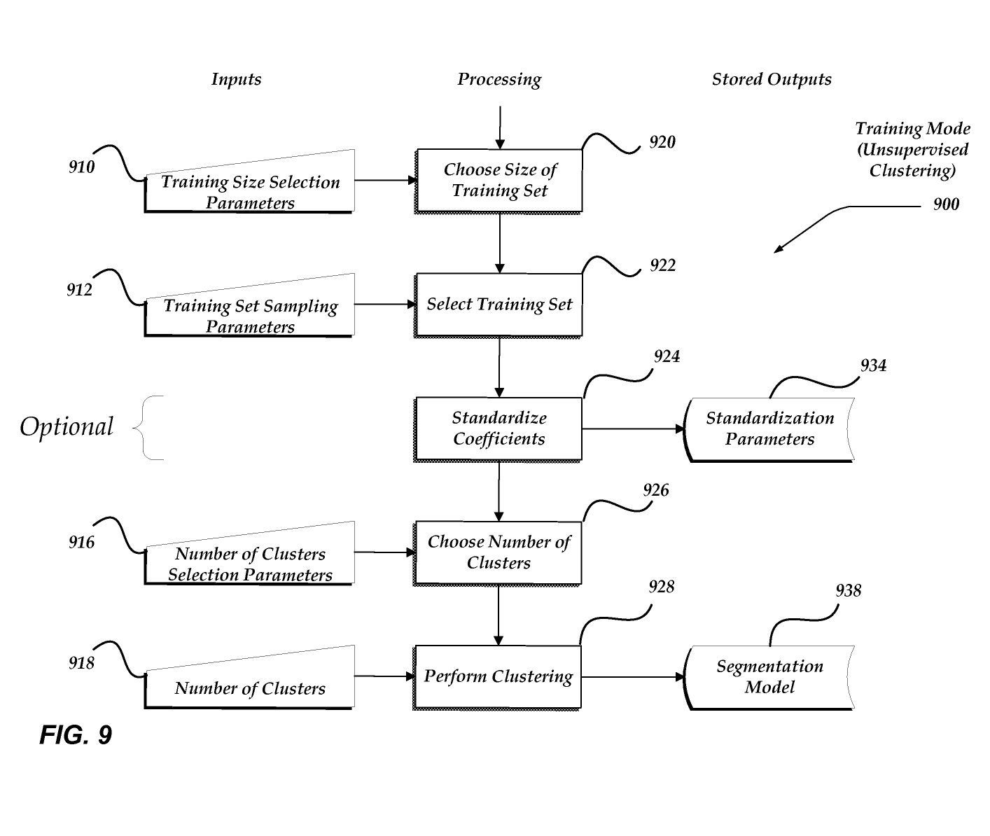

For the training mode, processing continues to blocks 512 and 514, which are described in more detail below in conjunction with FIG. 9. Briefly, at block 512, in one embodiment, an unsupervised clustering of the data is performed using the spectral coefficients from block 504. At block 514, in one embodiment, the training data is modeled as a Gaussian mixture model that is useable to define a segmentation model.

Moving to block 516, a result of the scoring provides a classification of testing data into one of the established customer segments. In one embodiment, as shown in FIG. 5, frontend processing may be common to both training of the unsupervised clustering, and the classification of unseen data. Thus, FIG. 5 includes both training and classification.

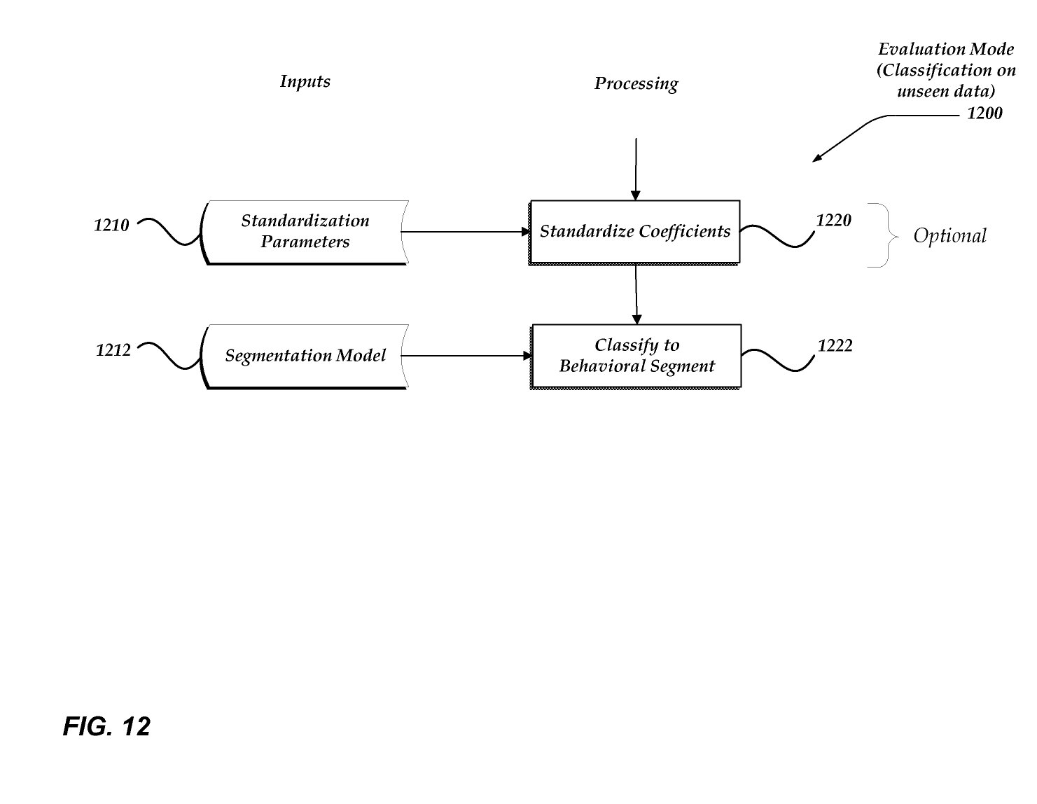

In any event, once a model has been trained, it may be used for scoring unseen customer data. That is, processing flows to block 516, where unseen customer data is received at block 502 and processed at block 504. The evaluation mode is described in more detail below, at least with respect to FIG. 12. Briefly, however, the output of block 504 in the evaluation mode, as in the training mode, is a representation of the customer behavior as spectral coefficients. Flowing next to block 518 (also discussed further below in conjunction with FIG. 12), the customer data is then classified into one of a plurality of behavioral segments.

Continuing next to decision block 520, a determination is made whether to continue performing actions of process 500 on more data. A determination might be positive, for example, where process 500 is first performed using training data, and then performed using unseen customer data. Thus, if processing is to continue for more data, then process 500 branches back to block 502 to receive more data.

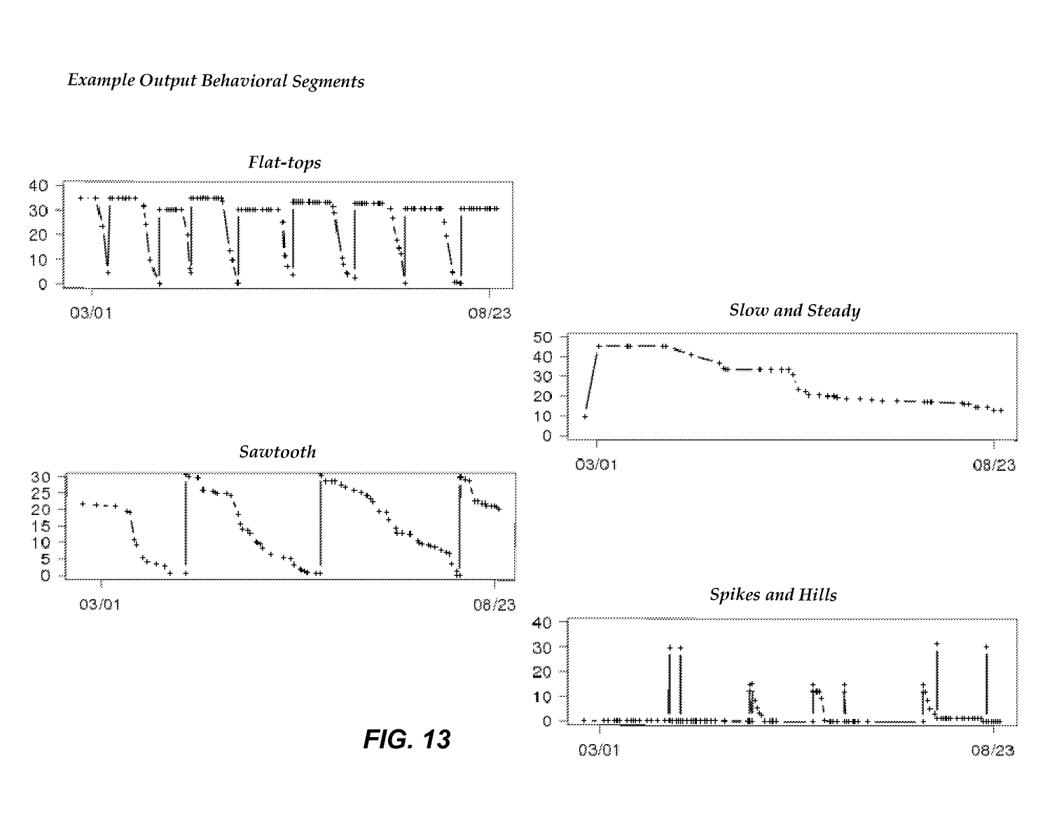

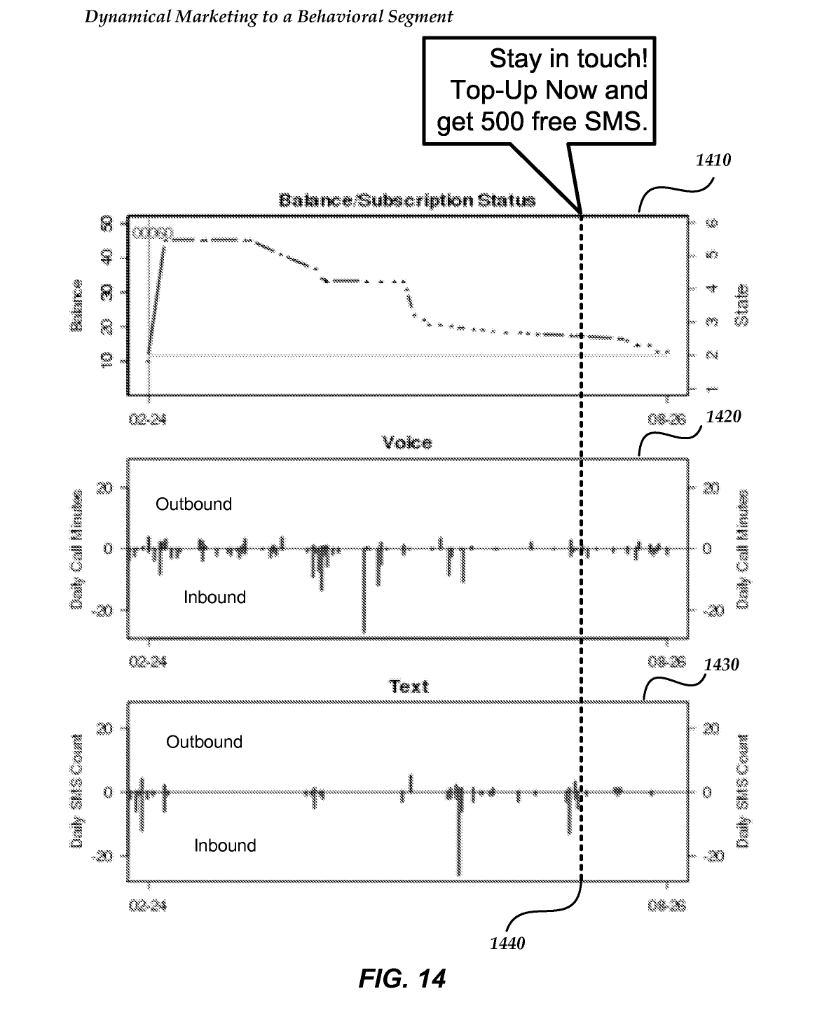

Otherwise, if processing of more data is not to continue, then processing flows to block 522, where the behavioral segments are used to identify an opportunity to provide an offer to one or more customers. Examples of identifying such opportunities are discussed in more detail below in conjunction with FIGS. 13-14. Then flowing to block 524, an appropriate offer is provided to an identified customer or customers at a determined time, location, and/or using a selected mechanism for transmitting the offer. Process 500 then returns to a calling process. While process 500 is shown in FIG. 5 as returning to a calling process, in other embodiments, process 500 might be re-entered at block 502, a plurality of times, based on a determination to retrain the model, and/or to evaluate additional customer data.

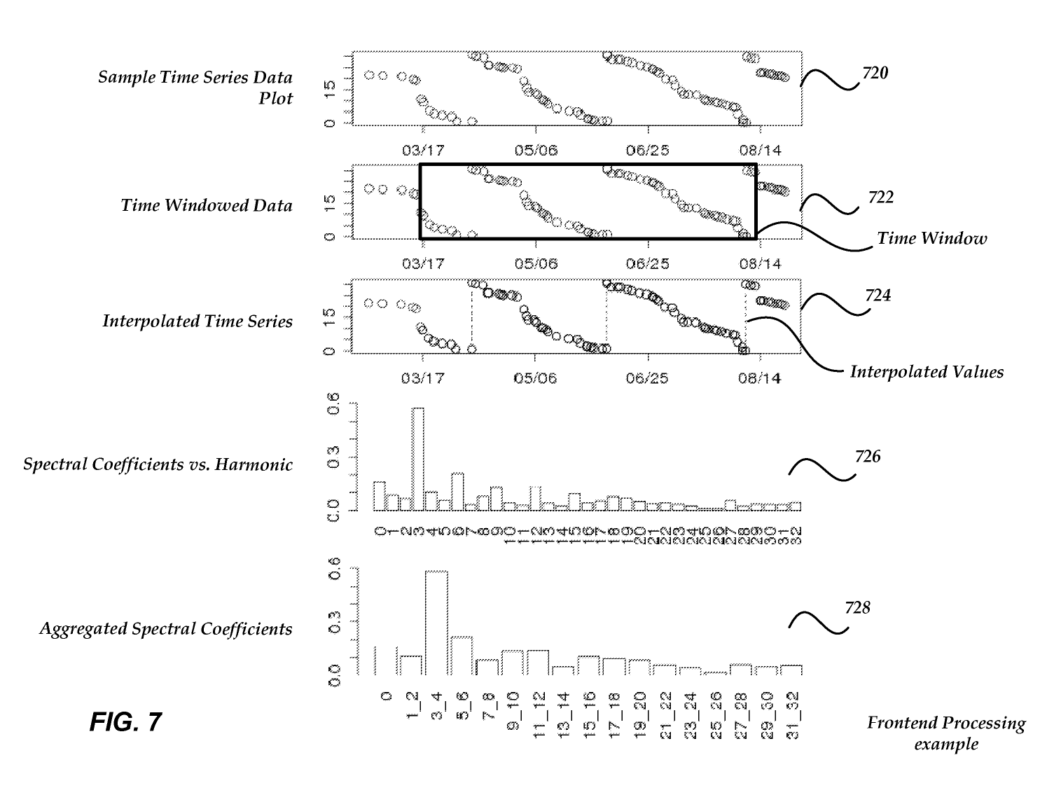

As noted elsewhere, while several sections illustrate telecommunications data, such as FIG. 7, for example, such data are to be understood as examples, and are not limiting, or exhaustive. Rather, they are merely provided to assist in understanding of the embodiments disclosed herein.

Further, at least some figures include one or more sections that are identified as “optional.” As such, it should be understood that such sections might not be performed in some embodiments.

In addition, it will be understood that each block of the flowcharts, and combinations of blocks in the flowcharts, can be implemented by computer program instructions. These program instructions may be provided to a processor to produce a machine, such that the instructions, which execute on the processor, create means for implementing the actions specified in the block or blocks. The computer program instructions may be executed by a processor to cause a series of operational steps to be performed by the processor to produce a computer-implemented process such that the instructions, which execute on the processor to provide steps for implementing the actions specified in the block or blocks. The computer program instructions may also cause at least some of the operational steps shown in the blocks to be performed in parallel. Moreover, some of the steps may also be performed across more than one processor, such as might arise in a multiprocessor computer system. In addition, one or more blocks or combinations of blocks in the illustration may also be performed concurrently with other blocks or combinations of blocks, or even in a different sequence than illustrated without departing from the scope or spirit of the subject innovation.

Accordingly, blocks of the illustration support combinations of means for performing the specified actions, combinations of steps for performing the specified actions and program instruction means for performing the specified actions. It will also be understood that each block of the illustration, and combinations of blocks in the illustration, can be implemented by special purpose hardware-based systems, which perform the specified actions or steps, or combinations of special purpose hardware and computer instructions.

The following provides non-limiting, non-exhaustive additional flows, additional details, and examples of how various embodiments might be employed to provide contextual offerings to a customer (at block 524 of process 500) according to the time series-based entity classification disclosed herein. It should be noted that the following examples are not to be construed as limiting the scope of the subject innovation. Rather, they are merely provided to illustrate non-limiting examples of possible uses of the subject innovation. Furthermore, the examples presented are not exhaustive examples.

FIG. 6 illustrates the flow diagram for a process 600 of one embodiment of the frontend processing module (block 504 shown in FIG. 5), which is common to both the training and evaluation modes. FIG. 7 is an illustrative example of the frontend processing applied to telecommunications data. FIGS. 6 and 7 may be viewed in conjunction with each other, with FIG. 6 illustrating a process flow and FIG. 7 providing one non-limiting, non-exhaustive example. Neither FIG. 6 nor FIG. 7 should be construed as limiting the scope of the subject innovation, but rather as aids in understanding the presented embodiment.

As discussed above in conjunction with FIG. 5, raw customer data 610 (of FIG. 6) is ingested and may be represented as a time series, at block 620 of FIG. 6. Time series data plot 720 (one example of which is shown in FIG. 7) may represent customer account balance, customer activity, or more generally any customer attribute that has a time-varying aspect. The ordinate of the time series data plot 720 is a customer attribute under consideration and the abscissa of time series data plot 720 is time.

The frontend processing in block 504 of FIG. 5 may be applied to data from a plurality of customers. The data are processed and put into a form where data from different customers can be compared to each other on the same basis. As an illustrative example, the customer attribute might be telecommunications activity and a corresponding representation might be activity per unit time. Different customers might have activity data from periods of differing duration; but the under the representation of activity per unit time basis, they may be compared to each other either directly or indirectly.

In another embodiment, the frontend processing involves frequency-domain analysis. The remainder of the description of FIGS. 6 and 7 will concentrate on the frequency-domain embodiment, but it is to be understood that this description does not limit the scope of the subject innovation. Frequency-domain analysis may be carried out over a specific time window. Different customers may have attributes recorded over differing periods. Their frequency-domain representations may be compared when they pertain to time windows of the same duration T. Thus, step 622 of FIG. 6 selects the time window within which frequency-domain analysis will be carried out. The time window selection is illustrated by plot 722 in FIG. 7.

The time window selection technique handles the real-world data recording conditions that were mentioned previously, namely incomplete data or time samples that are spaced irregularly. In some situations, a designer may be interested in determining the evolution of a customer's behavioral classification over time. In the embodiment where the time series represents customer account balance, for example, the designer may want to know when a customer changes the frequency or denomination of recharges. These changes may be induced by changes in the customer's job or pay-day timing, for example. Some changes in observed behavior may also be attributed to a change in the customer's rate plan. These changes may be detected by carrying out a time series based segmentation over multiple time windows of duration T and noting different behavioral classifications for each window.

Some embodiments also allow the designer to impose certain constraints that may be useful for the analysis. For example, the designer may want to consider for analysis data within a fixed time range [τ₁, τ₂]. Moreover, the designer may be interested in activity at or above a certain level. Further, the designer may be interested in activity profiles that show at least a minimum amount of variation. These constraints may be implemented as filters that can be applied to select customer time series that satisfy the designer's intended constraints. Such time window parameters are represented by block 612 of FIG. 6. It should be noted that these constraints are optional and dependent on the designer's goals.

In one embodiment, the frequency-domain analysis is carried out by first interpolating the time series to a uniform time grid. This is shown as the optional processing step 624 in FIG. 6, with interpolation parameters being represented by 614. The design of the interpolation scheme depends to a great extent on the nature of the data being interpolated. Smoothly varying data demands a different type of interpolation as compared to data that features abrupt changes. To satisfy the demands of data that exhibit both kinds of characteristics, i.e. smooth and abrupt, a hybrid interpolation scheme may be applied. In one embodiment, the hybrid interpolation scheme may use a linear spline interpolation as its basis, which captures smoothly varying data well. Linear spline interpolation may, however, potentially miss abrupt changes in the time series, depending on the phasing of the abrupt change relative to the uniform time grid and the surrounding smoothly varying data points. The hybrid interpolation scheme detects possible omissions of abrupt changes by monitoring successive differences (which are a discrete approximation of the derivative) in both the linear interpolated values as well as the original data. At points where the former is small and the latter is large, the hybrid interpolation scheme substitutes the nearest raw data sample for the linear interpolated value. This is a non-limiting example of one embodiment of the hybrid interpolation scheme. The hybrid-interpolated time series for the telecommunications example is shown in plot 724 of FIG. 7.

In the embodiment where the time series are interpolated to a uniform time grid, the frequency-domain analysis may be carried out by computing a Discrete Fourier Transform (DFT) at block 626 of FIG. 6. There are standard techniques and packages for computing DFTs, such as, for example, FFTW, which implements the Fast Fourier Transform algorithm. It should be noted that other transforms may also be used to estimate spectral content, including, for example, using a wavelet transform.

In the embodiment where the time series are used as is, that is, with irregularly spaced samples, the frequency-domain analysis may take a different approach. In one embodiment, the frequency-domain analysis is carried out by computing the Fourier Series representation of the attribute under consideration. For the purposes of this analysis, the attribute is considered to be a periodic function, with period equal to the time window duration τ. The Fourier Series coefficients cₘ are computed out to a finite number of harmonics m=1, . . . , M, which may be represented by input 616. The function values are known at a finite number of irregularly spaced times, therefore the function may be represented as a piecewise linear function. This representation is equivalent to linear interpolation. A special case of the piecewise linear representation is piecewise constant, wherein the linear terms are constrained to be zero. Under the piecewise linear assumption, the Fourier integral for the coefficients may be computed analytically as a sum of integrals, each of whose limits are the left and right endpoints of the successive intervals defined by the time samples.

To express these notions mathematically, some notation may be introduced. Let y denote the customer attribute of interest, which is treated as a time-varying signal. The values of y are known at the L time points t₁, . . . , t_{L}; in general, these may be irregularly spaced. The shorthand notation yᵢ [symbol] y(tᵢ) is used. The signal y is expanded in a finite Fourier Series as follows:

$$y ( t ) = {\sum }_{m = 0}^{M} {c}_{m} {e}^{- 2 πi mt / τ}$$

where i=\sqrt{−1}. The Fourier Series coefficients may be calculated via the Fourier integral:

$${c}_{m} = \frac{1}{τ} {\int }_{0}^{τ} y ( t ) {e}^{2 πi mt / τ} , m = 0 , … , M$$

The m=0 term is computed separately via the Trapezoidal Rule:

$${c}_{0} = \frac{1}{2 τ} {\sum }_{i = 1}^{L - 1} ( {t}_{i + 1} - {t}_{i} ) ( {y}_{i + 1} + {y}_{i} )$$

For the computation of the other terms, the signal y is represented as a series of line segments between sample points t₁, . . . , t_{L}. Thus, the Fourier Integral may be expressed as follows:

$${c}_{m} = \frac{1}{τ} {\sum }_{i = 1}^{L - 1} {\int }_{{t}_{i}}^{{t}_{i + 1}} ( {a}_{i} + {b}_{i} t ) {e}^{2 πi mt / τ} , m = 1 , … , M$$

$$where$$

$${a}_{i} = \frac{{t}_{i + 1} {y}_{i} - {t}_{i} {y}_{i + 1}}{{t}_{i + 1} - {t}_{i}}$$

$${b}_{i} = \frac{{y}_{i + 1} - {y}_{i}}{{t}_{i + 1} - {t}_{i}}$$

The individual terms in the sum may be computed analytically using integration by parts, i.e. ∫d(uv)=∫udv+∫vdu. After computing the integrals and performing some algebraic manipulations the following may be obtained:

$${c}_{m} = \frac{1}{{( 2 π m )}^{2}} {\sum }_{i = 1}^{L - 1} [ 2 πi {ma}_{i} ( {e}_{i + 1} - {e}_{i} ) + τ {b}_{i} ( {e}_{i + 1} - {e}_{i} ) + 2 πi {mb}_{i} ( {t}_{i + 1} {e}_{i + 1} - {t}_{i} {e}_{i} ) ]$$

where the shorthand notation eᵢ [symbol] e^{-2πim t}^{ᵢ}^{/τ} has been introduced. The piecewise constant representation may be recovered from this formula by setting bᵢ=0 and aᵢ=y₁. The spectral coefficients that are used in the frequency-domain analysis are the complex moduli of the Fourier Series coefficients, sₘ [symbol] ∥cₘ∥. This is directed toward ensuring that the spectral coefficients are time-invariant: the same activity pattern will lead to the same coefficients irrespective of temporal translation. The spectral coefficients for the telecommunications example are shown in bar chart 726 of FIG. 7.

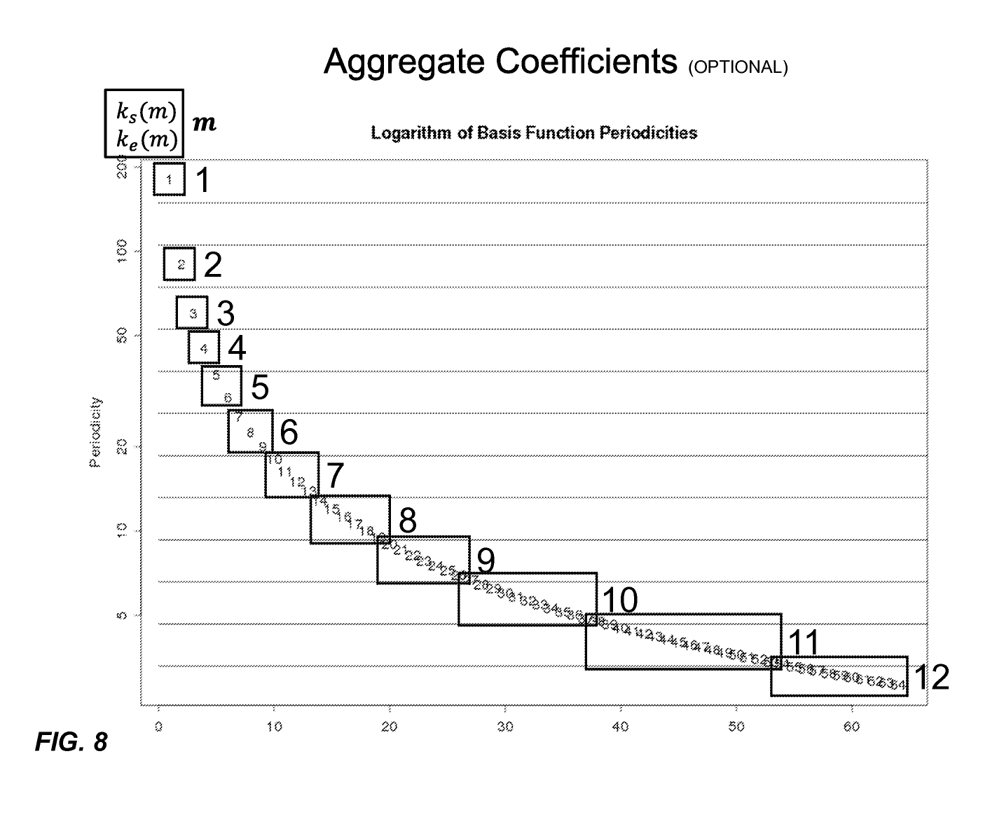

The next stage of the frontend processing module is the optional coefficient aggregation step 628 in FIG. 6. Coefficient aggregation helps to alleviate the impact of noise in the estimation of the spectral coefficients. In one embodiment, coefficients are aggregated linearly; that is, they are aggregated q coefficients at a time. For example q=2 means that coefficients for m=1 and m=2 are aggregated, coefficients for m=3 and m=4 are aggregated, and so on. The linearly aggregated spectral coefficients for the telecommunications example are shown in bar chart 728 of FIG. 7. In another embodiment, coefficients are aggregated logarithmically; that is, coefficients corresponding to a range of frequencies are aggregated such that the spacing between successive start-of-range frequencies is uniform in the logarithm of frequency. FIG. 8 illustrates the concept of logarithmic aggregation. In both the linear and logarithmic aggregation schemes, the m=0 term is not aggregated. Furthermore, in both the linear and logarithmic aggregation schemes, aggregation is via a root-mean-square computation. For example, in the q=2 linear aggregation scheme,

$${x}_{1} = \sqrt{\frac{1}{2} ( {s}_{1}^{2} + {s}_{2}^{2} )} , {x}_{2} = \sqrt{\frac{1}{2} ( {s}_{3}^{2} + {s}_{4}^{2} )} , … and so on .$$

A word is in order about the choice of input parameters for the frontend processing module. In the embodiment that employs frequency-domain analysis, the duration of the time window τ is a fundamental parameter. This parameter determines the frequency resolution of the analysis according to the formula δf=1/τ. The longer the time window, the finer the frequency resolution. The duration of the time window is chosen long enough that activity patterns with significant differences in periodicity can be resolved. Another fundamental parameter is the number of harmonics M in the Fourier Series expansion. This parameter determines the highest temporal frequency that can be characterized, which is the so-called Nyquist critical frequency given by f_{c}=M/(2τ). The number of harmonics 616 is typically chosen high enough that the fastest observed activity patterns that are of interest can be properly characterized. Input 618 of FIG. 6 represents the aggregation parameters discussed above.

Next is described one embodiment of a process that may be used to train the behavioral classification model, with reference to process 900 of FIG. 9. Typically, the amount of time used to train the model scales super-linearly with the number of patterns used for training. To avoid long training times, the number of training patterns N is chosen judiciously (as represented by input 910). Thus, the first step of the training process is the selection of the optimal number of training samples, which is shown as block 920 in FIG. 9. The following notation is used: Xₜᵣₙ refers to the training set, and Xₜₛₜ refers to the testing set. Under this notation, =|Xₜᵣₙ|. A cross-validation technique may be used to select the minimum number of training patterns. A model trained on too few patterns may be overfit when applied to out-of-sample data (i.e. the testing set). In other words, in an overfit situation the log-likelihood of the training data per sample may exceed the log-likelihood of the testing data per sample. Viewed as a function of the size of the training set, these likelihoods may tend to converge as N increases.

Some notation may be introduced to quantify these observations. The log-likelihood of a data set X given a model Θₖ with k clusters is denoted by L(X|Θₖ). The unit log-likelihood difference between the training set and the testing set may be defined as follows:

$$λ ( \vert {𝒳}_{trn} \vert , \vert {𝒳}_{tst} \vert , {Θ}_{k} ) {=}^{def} \frac{ℒ ( {𝒳}_{trn} \vert {Θ}_{k} )}{\vert {𝒳}_{trn} \vert} - \frac{ℒ ( {𝒳}_{tst} \vert {Θ}_{k} )}{\vert {𝒳}_{tst} \vert}$$

Models are trained with an ensemble of training sets having a range of sizes, |Xₜᵣₙ|ε{Nₘᵢₙ, . . . , Nₘₐₓ}. These models are scored on testing sets that are disjoint from the training sets, i.e. there is no overlap between training and testing patterns. The log-likelihoods of the training and testing sets are computed and from these the unit log-likelihood difference is computed. These computations are averaged over a number of independent random samplings of the training and testing sets, which has the effect of reducing the amount of variance in the result. The computations are also averaged over models with different complexity, that is, models with different number of clusters kε{Kₘᵢₙ, . . . , Kₘₐₓ}. The averaged unit log-likelihood difference may be obtained as:

$$\overline{λ} ( \vert {𝒳}_{trn} \vert ) {=}^{def} {mean}_{k , {𝒳}_{trn} , {𝒳}_{tst}} λ ( \vert {𝒳}_{trn} \vert , \vert {𝒳}_{tst} \vert , {Θ}_{k} )$$

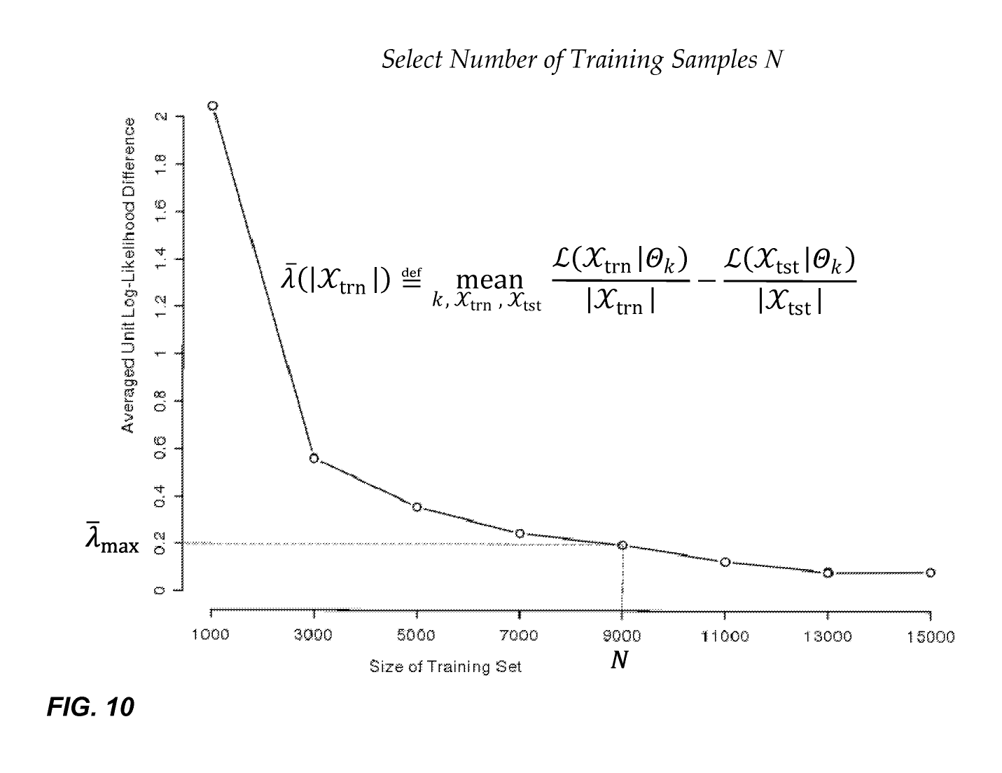

Considered as a function of |Xₜᵣₙ|, the averaged unit log-likelihood difference is a monotonically decreasing function. The minimum training set size may be determined as the point when the function falls below a specified threshold λ̅ₘₐₓ. This is illustrated in FIG. 10.

The next step in the training process is to sample from among the available customer patterns to select the training set. This is shown as block 922 in FIG. 9. In addition to the time-varying customer attribute that is being used to segment customers into behaviorally similar segments, there are also static attributes that characterize customers. The customers in the training set for the behavioral segmentation model may be chosen so that they have a similar frequency distribution on one or more of the static attributes as the entire set of customers. This is directed towards ensuring that the customers in the training set are in some sense representative of the entire population of customers. The selection is made on the basis of proportional sampling according to the frequency distribution of one or more static attributes (as represented by input 912). The proportional sampling technique is also applied in the selection of each of the training sets in the ensemble of training sets of step 920 of FIG. 9 described previously.

The next stage of processing is the optional step of standardizing the spectral coefficients, which is shown as block 924 of FIG. 9. Standardization is a statistical procedure that scales and translates individual values of a random variable to a so-called z-score. The z-score measures how many standard deviations above or below the mean the current value of the variable is. Suppose that x is a random variable. The z-score is given by z=(x−μ)/σ, where μ is the mean value of x, and σ is the standard deviation of x. The mean and standard deviation are taken across the training set and are computed for each dimension of the spectral coefficients separately. In the embodiment that excludes the optional aggregation step 628 of FIG. 6, the spectral coefficients x are (M+1)-dimensional vectors. Thus, the mean μ and standard deviation σ are also (M+1)-dimensional vectors. In the embodiment that includes the standardization step 924 of FIG. 9, the mean μ and standard deviation σ are stored for use during the scoring process.

One aspect of unsupervised clustering is choosing the number of clusters, which is shown as block 926 of FIG. 9. This is a difficult task because it is not a well-posed problem. A number of heuristic solutions have been proposed in the machine learning literature. In one embodiment, the log-likelihood function that was used previously to select the number of training samples may be used in conjunction with a cross-validation technique. The number of clusters is closely related to the complexity of the segmentation model. Models that are too complex may be overfit when applied to out-of-sample data. This can be observed in the shape of the testing set unit log-likelihood function, which is computed by averaging over different training and testing samples. The testing set unit log-likelihood function is defined as follows:

$${l}_{tst} ( k ) {=}^{def} {mean}_{{𝒳}_{trn} , {𝒳}_{tst}} \frac{ℒ ( {𝒳}_{tst} \vert {Θ}_{k} )}{\vert {𝒳}_{tst} \vert}$$

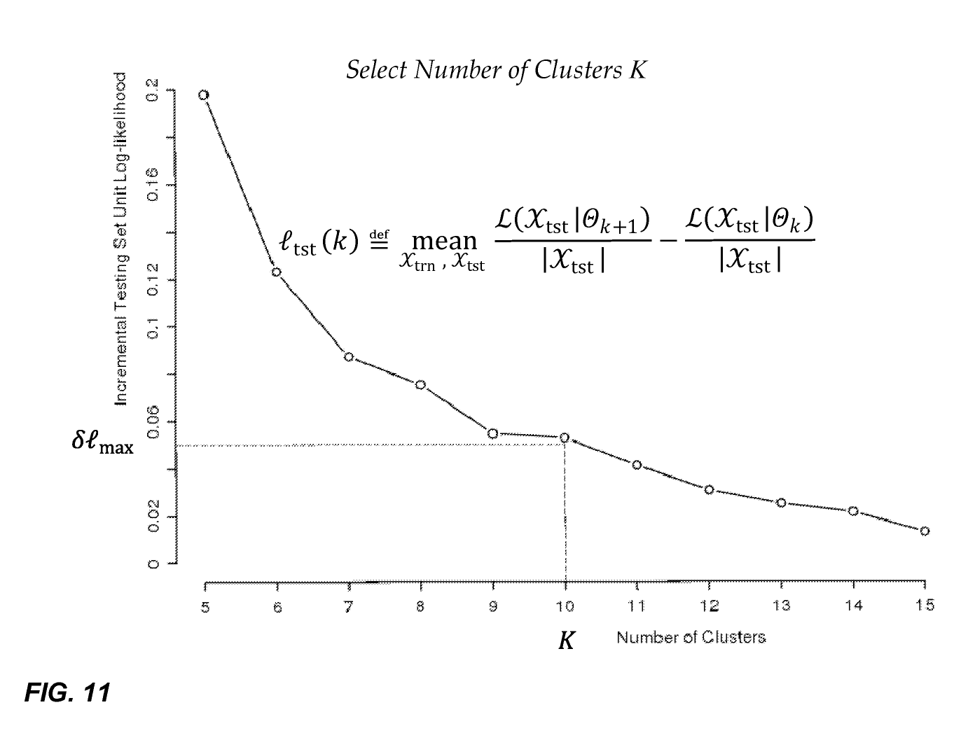

It is viewed as a function of the number of clusters in the model, k. At first, lₜₛₜ rises with increasing number of clusters because the model starts fitting the testing set better, but then does one of two things: (a) peaks and then starts falling again, or (b) levels off to an asymptote. In case (a), the fit to the testing data becomes worse as more clusters are added. In case (b), it may be a matter of diminishing returns: more clusters might fit marginally better. The successive difference function may be defined as δlₜₛₜ(k) [symbol] lₜₛₜ(k+1)−lₜₛₜ(k). In both case (a) and case (b), δlₜₛₜ(k) is a monotonically decreasing function of its argument. The optimal number of clusters k=K may be determined as the point when the successive difference function falls below a specified threshold δlₘₐₓ. This is illustrated in FIG. 11.

The last step of the training stage is to perform the unsupervised clustering, which is shown as block 928 in FIG. 9. There are a variety of clustering techniques available. One embodiment of the current subject innovation employs a k-means clustering technique. The k-means clustering technique computes a cluster center μₖ for each of k=1, . . . , K clusters.

It should be noted that supervised classification may be used in place of unsupervised clustering in block 928 of FIG. 9. In these embodiments, the designer may hand-select (as user pre-scribed) a plurality of groups of customers based on similar observed temporal behavior patterns as represented by their time series. In any event, whether supervised classification or unsupervised clustering is used, the model generated in the training process is used as a segmentation model.

A different embodiment employs model-based clustering. Next is described an embodiment that employs a model-based clustering technique in the form of a Gaussian mixture model, as this is the preferred embodiment. The Gaussian mixture model technique models the training patterns as a mixture of K Gaussian components. Each component may be modeled as a multivariate Gaussian with its own mean and covariance matrix. The computation proceeds via an iterative algorithm that alternates between an expectation step, where the likelihood of membership of each pattern to each cluster (component) is computed, and a maximization step, where the parameters for each cluster are computed based on maximizing the likelihood function. This is the classic expectation-maximization algorithm, often simply abbreviated as EM. The end result of applying the EM algorithm to the Gaussian mixture model clustering is the set of parameters that define each cluster. Namely, for clusters k=1, . . . , K, the EM algorithm computes a mean vector μₖ, a covariance matrix Σₖ, and a component fraction Pₖ. Together, these define the Segmentation Model illustrated as block 938 of FIG. 9.

In the Evaluation Mode of FIG. 5, an input pattern of customer data is subjected to the same frontend processing as has been described previously in relation to the training of the Segmentation Model. The output of the frontend processing is a representation of the customer behavior consisting of the aggregated spectral coefficients as illustrated in bar plot 728 of FIG. 7. The goal of Evaluation Mode is to classify the customer into one of the K behavioral segments that were established during the Training Mode. One embodiment of a flow diagram for the Evaluation Mode of the process of FIG. 5 is shown in more detail in process 1200 of FIG. 12.

The first step of Evaluation Mode, standardizing the coefficients, is shown as block 1220 in FIG. 12, and is optional. The choice of whether to standardize the coefficients or not in Evaluation Mode is matched to the choice of standardizing the coefficients in Training Mode: in one embodiment, the coefficients are standardized in both Training Mode and in Evaluation Mode; in an alternative embodiment, the coefficients are standardized in neither Training Mode nor in Evaluation Mode.

The next step in Evaluation Mode, classification, is shown as block 1222 in FIG. 12. In the embodiment that employs a k-means clustering technique, the classification is carried out by classifying the current customer to the cluster which has the closest cluster center μₖ (in the spectral coefficient space). That is, if x is the spectral coefficient representation for the current customer, and C is the cluster to which it is assigned,

$$C = {arg min}_{k = 1 , … , K} {‖ x - {μ}_{k} ‖}^{2}$$

For the embodiment that employs model-based clustering, the posterior probability of the current customer's behavior pattern is used for the classification. That is, for the Gaussian mixture model embodiment,

$$C = {arg max}_{k = 1 , … , K} {P}_{k} P ( x \vert C = k )$$

where P(x|C=k) is the multivariate normal model distribution given by

$$P ( x \vert C = k ) = {( 2 π )}^{- d / 2} {( {det Σ}_{k} )}^{- 1 / 2} exp [ - \frac{1}{2} {( x - {μ}_{k} )}^{T} {Σ}_{k}^{- 1} ( x - {μ}_{k} ) ]$$

and where d is the dimensionality of the spectral coefficient representation. In the embodiment where there is no aggregation, d=M+1.

FIG. 13 illustrates a non-limiting, non-exhaustive example of employing the time series-based behavioral segmentation to telecommunications data. Four distinct patterns of behavior emerge from the unsupervised clustering. The four plots shown in FIG. 13 show the customer account balance as a function of time for one representative customer from each cluster. These clusters have been labeled (1) Flat-tops, (2) Sawtooth, (3) Slow and steady, and (4) Spikes and hills, as these labels are descriptive of the temporal patterns of activity seen in the plots of FIG. 13.

FIG. 14 illustrates a non-limiting, non-exhaustive example of employing the time series-based behavioral analysis to dynamically market offerings to one of the behavioral segments shown in FIG. 13. The “Slow and Steady” cluster consists predominantly of customers whose usage levels are low and sporadic and who recharge their account balance consistently but spaced out in time. The static attributes of this group also have a distinct profile: these customers tend to be older than 55 years of age (in this example). The marketing goal for this cluster would be to use offers designed to stimulate usage in the context of active usage; since their usage is sporadic, messages sent to members of this cluster outside of the context of active usage may be missed by the customer. Plot 1410 of FIG. 14 shows the customer account balance as a function of time; this is the time-varying attribute that was used as input to the time series-based behavioral segmentation. Plot 1420 shows the same customer's daily call activity; positive spikes correspond to outbound voice calls, while negative spikes correspond to inbound calls. Plot 1430 shows the same customer's SMS activity, with positive spikes corresponding to outbound SMS counts, and negative to incoming SMS counts. Plots 1420 and 1430 are temporally aligned to plot 1410. This customer tends to have short episodes of predominantly inbound calls and SMS. The dashed vertical line 1440 that runs through all three plots in FIG. 14 corresponds to a time when the customer's account balance is low, but there is a surge of inbound activity. This may be an appropriate time to message this customer with an offer designed to stimulate usage and recharge. Again, it should be understood that these are merely examples of how the time series-based behavioral classification might be used to dynamically market to a customer.

The above specification, examples, and data provide a complete description of the manufacture and use of the composition of the subject innovation. Since many embodiments of the subject innovation can be made without departing from the spirit and scope of the subject innovation, the subject innovation resides in the claims hereinafter appended.

What is claimed as new and desired to be protected by Letters Patent of the United States is:

1. A network device, comprising:
a transceiver to send and receive data over a network; and
a processor that is operative to perform actions, comprising:
receiving telecommunications customer data for a plurality of customers;
extracting from the data a time series for each of the plurality of customers;
computing for each of the plurality of customers, spectral content for each time series data within a time window;
performing a grouping from the spectral content to generate a plurality of groups; and
classifying each customer time series within one of the plurality of groups, the groups usable to dynamically market to at least one customer identified by a cluster.

2. The network device of claim 1, wherein performing a grouping from spectral content comprises an unsupervised clustering to generate a plurality of clusters, the groupings being identified with the clusters generated by the unsupervised clustering.

3. The network device of claim 1, wherein performing a grouping from spectral content comprises a supervised classification into a plurality of user-prescribed classes, the groupings being identified with the classes.

4. The network device of claim 1, wherein extracting a time series for each of the plurality of customers, further comprises performing an interpolation of each time series to a uniform time grid, using at least one of a smoothing, an abrupt, or a hybrid interpolation algorithm.

5. The network device of claim 1, wherein computing spectral content for each time series is based on determining coefficients of a Fourier series from each time series, and employing a complex moduli of the coefficients as spectral coefficients expressing spectral content of a each time series.

6. The network device of claim 3, wherein computing the spectral content further comprises performing an aggregation of the spectral coefficients for a time series.

7. The network device of claim 1, wherein performing grouping comprises selecting a number of groups to be used, based on employing a test set of data to compute a delta log-likelihood function for the test set of data, and selecting the number of groups when the delta log-likelihood function falls below a specified threshold value.

8. The network device of claim 1, wherein generating a plurality of groups comprises applying an expectation-maximization algorithm to a mixture model to generate the plurality of groups, and wherein classifying each customer further comprises computing likelihoods under the mixture model of the spectral coefficient representation for each customer, and associating the customer to the group with the largest likelihood among the plurality of groups.

9. The network device of claim 8, wherein the mixture model is a Gaussian mixture model.

10. A system, comprising:
one or more non-transitory storage devices usable to store customer data; and
one or more processors operative to perform actions, comprising:
receiving telecommunications customer data for a plurality of customers;
extracting from the data a time series for each of the plurality of customers;
computing for each of the plurality of customers, spectral content for each time series data within a time window;
performing grouping from the spectral content to generate a plurality of groups; and
classifying each customer time series within one of the plurality of groups, the groups usable to dynamically market to at least one customer identified by a group.

11. The system of claim 10, wherein extracting a time series for each of the plurality of customers, further comprises performing an interpolation of each time series to a uniform time grid, using at least one of a smoothing, an abrupt, or a hybrid interpolation algorithm.

12. The system of claim 10, wherein computing spectral content for each time series is based on determining coefficients of a Fourier transform from each time series, and employing a complex moduli of the coefficients as spectral coefficients expressing spectral content of a each time series.

13. The system of claim 12, wherein computing the spectral content further comprises performing an aggregation of the spectral coefficients for a time series.

14. The system of claim 10, wherein performing clustering grouping comprises selecting a number of groups to be used, based on employing a test set of data to compute a delta log-likelihood function for the test set of data, and selecting the number of groups when the delta log-likelihood function falls below a specified threshold value.

15. The system of claim 10, wherein generating a plurality of groups comprises applying an expectation-maximization algorithm to a mixture model to generate the plurality of groups.

16. The system of claim 15, wherein the mixture model is a Gaussian mixture model.

17. The system of claim 14, wherein classifying each customer further comprises computing likelihoods under the mixture model of the spectral coefficient representation for each customer, and associating the customer to the group with the largest likelihood among the plurality of groups.

18. An apparatus comprising a non-transitory computer readable medium, having computer-executable instructions stored thereon, that in response to execution by a computing device, cause the computing device to perform operations, comprising:
receiving telecommunications customer data for a plurality of customers;
extracting from the data a time series for each of the plurality of customers;
computing for each of the plurality of customers, spectral content for each time series data within a time window;
performing an unsupervised clustering from the spectral content to generate a plurality of clusters; and
classifying each customer time series within one of the plurality of clusters, the clusters usable to dynamically market to at least one customer identified by a cluster.

19. The apparatus of claim 18, wherein extracting a time series for each of the plurality of customers, further comprises performing an interpolation of each time series to a uniform time grid, using at least one of a smoothing, an abrupt, or a hybrid interpolation algorithm.

20. The apparatus of claim 18, wherein computing spectral content for each time series is based on determining coefficients of a Fourier series from each time series, and employing a complex moduli of the coefficients as spectral coefficients expressing spectral content of a each time series.

21. The apparatus of claim 18, wherein computing the spectral content further comprises performing an aggregation of the spectral coefficients for a time series.

22. The apparatus of claim 18, wherein performing an unsupervised clustering comprises selecting a number of clusters to be used, based on employing a test set of data to compute a delta log-likelihood function for the test set of data, and selecting the number of clusters when the delta log-likelihood function falls below a specified threshold value.

23. The apparatus of claim 18, wherein generating a plurality of clusters comprises applying an expectation-maximization algorithm to a Gaussian mixture model to generate the plurality of clusters.

24. The apparatus of claim 23, wherein classifying each customer further comprises computing likelihoods under the mixture model of the spectral coefficient representation for each customer, and associating the customer to the group with the largest likelihood among the plurality of clusters.
